(19) United States
(12) Patent Application Publication
(10) Pub. No.: US 2011/0303627 A1
(43) Pub. Date: Dec. 15, 2011

(54) PRECAST COPING LIFTING SYSTEM

(75) Inventors: Tae-Hoon KIM, Seongnam-si (KR); Se-Jin PARK, Seongnam-si (KR); Young-Jin KIM, Seongnam-si (KR); Seong-Woon KIM, Seoul (KR)

(73) Assignee: DAEWOO E&C CO., LTD., Seoul (KR)

(21) Appl. No.: 12/900,577

(22) Filed: Oct. 8, 2010

(30) Foreign Application Priority Data
Jun. 11, 2010 (KR) 10-2010-0055358

(51) Int. Cl. B66C 19/00

(52) U.S. Cl. 212/71

(57) ABSTRACT

The present invention relates to a precast coping lifting system, and more particularly to, a lifting system for lifting precast coping composed of a main segment and a subsegment, characterized in comprising: a hoist crane for installing a horizontal support on the top of the main segment and forming a pair of carriers on the horizontal support; a plurality of clamps for being installed on the top of the horizontal support of the hoist crane, being moved by the carrier of the hoist crane and fixing the subsegment to the top of the horizontal support; and work vehicle for being installed on the horizontal support of the hoist crane and being moved by self power along the horizontal support.

### TECHNICAL FIELD

The present invention relates to a precast coping lifting system. More particularly, the present invention relates to the precast coping lifting system which enables to install a main segment previously manufactured on the top of a pier body, and tension and fix each segment at once after fixing a subsegment on a same straight line in sequence by using a clamp on a rail of a hoist crane after lifting one or more subsegments to the side of the main segment by using the hoist crane after installing the hoist crane on the upper side of the main segment.

### BACKGROUND

Coping is formed on the top of a body in order to have a width corresponding to a transverse width of a bridge for supporting a girder in the top of a pier. Previously, after assembling and installing mould on the top of the bridge and pouring concrete while gradually constructing the bridge from the bottom of the bridge in place, concrete is cured and the coping is built on the top of the pier by disassembling the mould.

Meanwhile, the construction of bridges due to cast-in-place concrete has been less used for the reasons of the long period of construction, environmental problems, and civil complaints caused by environmental problems. Instead, the method for quick assembling and constructing pre-formed segments in a construction site has been widely used.

The fast construction method has been appearing as an alternative in that not only can the whole period of bridge construction be reduced, but environmental problems and civil complaints can be minimized. Also, it is true that the fast construction method helps construction environment mechanized by using large equipment.

There are advantages in which since a unit structure manufactured as a precast type, i.e., a segment, is manufactured in a uniform place and the quality of concrete is easily maintained, it is easy to maintain high-quality members; since segments are continuously manufactured, it is easy to control manpower and be used for mould only; and since segments may be manufactured with base construction, air may be cut as compared with the cast-in-place method.

If the assembling method is used, the bridge is constructed by gradually lifting up and assembling the pier body and the coping, manufactured with a plurality of segments, with cranes after building base concrete in which base sites are dug from the surface of the ground in place.

As above, in case that bridges are constructed by the assembling method, the body and the coping, composed of each unit structure, are lifted up by cranes and therefore, it may be much safer as self weight is getting reduced.

Therefore, the method for reducing the weight of the segment has been mainly studied. However, even though the weight of the segment is decreased, bearing capacity or seismic performance of the assembled bridges should not be diminished.

Especially, as for bridges, since a post and a coping are mainly affected by compressive load and bending load, respectively, the size of the side of the coping is generally large. Also, since the coping is usually more than a minimum of 10 meters long, the total weight of the coping is commonly quite heavy.

Therefore, the way to sharply reduce the self weight of the coping should be found out in order to seek the assembly bridge constructing method. As for girders, the size of the load for the coping is approximately 500 tons, five times of the size of the load for each girder, whereas the size of the load for each girder is generously approximately 100 tons. Therefore, the size of the side of the coping should be extremely bigger than that of the girder.

For this reason, the weight of the coping must be extremely large and therefore, the way to reduce self weight has been studied for fragmenting the coping.

To solve the above problem, the method for fragmenting the coping by a segment unit was invented by the applicant of the present invention.

Such previous precast coping lifts and assembles each segment on the surface of a bridge by using lifting devices like crane, or installs each segment by using lifting devices after assembling each segment on the ground.

However, in case that each segment is lifted by using lifting devices and assembled on the surface of the bridge, it is necessary to require a plurality of lifting devices for lifting each segment. Also, in case that each segment is assembled on the ground and lifted by lifting devices, it is necessary to require a device which enables to lift up the coping. Therefore, a device for effectively lifting segments urgently needs to be invented.

### BRIEF DESCRIPTION OF THE DRAWINGS

FIG. 1 is a side view representing the precast coping lifting system of the present invention;

FIG. 2 is a side view representing the constitution of the horizontal support of the precast coping lifting system of the present invention;

FIG. 3 is a perspective drawing representing the constitution of the clamp of the precast coping lifting system of the present invention;

FIG. 4 is a perspective drawing representing the constitution of the clamp of the precast coping lifting system of other embodiments of the present invention;

FIG. 5 is a perspective drawing representing the constitution of the clamp of the precast coping lifting system of another embodiments of the present invention; and

FIGS. 6 to 15 are explanation drawings for explaining the construction process using the precast coping lifting system of the present invention.

### DETAILED DESCRIPTION OF THE INVENTION

### Problems the Invention Solves

To solve the above problems, the object of the present invention is to provide the precast coping lifting system which enables to install a main segment previously manufactured on the top of a pier body, and tension and fix each segment at once after fixing a subsegment on a same straight line in sequence by using a clamp on a rail of a hoist crane after lifting one or more subsegments to the side of the main segment by using the hoist crane after installing the hoist crane on the upper side of the main segment.

Further, the other object of the present invention is to provide the precast coping lifting system which installs a pair of carriers on a guide rail of the hoist crane, reduces a period of construction after each carrier moves segments simultaneously with lifting segments, and disperses weight.

Addition, the other object of the present invention is to provide the precast coping lifting system which installs work vehicles on the guide rail of the hoist crane and then instantly performs operation without installing a separate supporting post after listing segments.

### Technical Problem

To accomplish the above object, the present invention is directed to a precast coping lifting system having a main segment and a subsegment, characterized in comprising: a hoist crane for installing a horizontal support on the upper side of the main segment and having a pair of carriers on the horizontal support; a plurality of clamps for being installed on the horizontal support of the hoist crane, being moved by the carrier of the hoist crane, and fixing the subsegment to the horizontal support; and work vehicles for being installed on the horizontal support of the hoist crane and being moved along the horizontal support by self power.

Here, the horizontal support includes a first guide rail for moving the carrier in longitudinal direction of the horizontal support; a second guide rail for being protruded in “L” shape to move the clamp in both sides of the horizontal support; and a third guide rail for being protruded in “L” shape to move the work vehicles while keeping a distance from the second guide rail.

Further, the second guide rail and the third guide rail form opening in both ends so that the clamp and the work vehicles are lifted and combined by the carrier.

Furthermore, the clamp, made of metal, forms “ [symbol] ”-shaped sides to connect to the second guide rail with having the subsegment, includes a plurality of wheels on the bottom of both ends inside the top, and includes a connection ring outside the upper side.

Also, the clamp further comprises an inclined support panel for having a hinge spot in the bottom inside for corresponding to a low inclined side of the subsegment; and ascending and descending means for sticking the inclined support panel to the low inclined side of the subsegment with combining the hinge spot and the axis of the inclined support panel.

In addition, the clamp further comprises a shock absorber to protect damage of the subsegment inside.

Here, the clamp separates one side and the bottom each other so that the clamp and the subsegment can be easily combined and dismantled, and the separated part is gathered by a hinge.

Also, the up-and-down sides and both sides of the clamp are separated by a segment unit and combined each other so that the length of the clamp may be changed in accordance with the size of the subsegment.

Further, the clamp protrudes and forms a fixed projection to fix the clamp adjacent to both sides, or the clamp in opposite sides each other by using combination means such as wires, chains, ropes.

Furthermore, the horizontal support is combined and fixed to the body segment by using a steel bar after installing the main segment on the upper side of the body segment, and is combined to the steel bar on the upper side of the main segment under the condition that a pier bridge, the body segment and the main segment are longitudinally tensioned.

### Effects

The precast coping lifting system of the present invention, constructed as above, enables to install a main segment previously manufactured on the top of a pier body, and tension and fix each segment at once after fixing a subsegment on a same straight line in sequence by using a clamp on a rail of a hoist crane after lifting one or more subsegments to the side of the main segment by using the hoist crane after installing the hoist crane on the upper side of the main segment.

Further, the present invention enables to install a pair of carriers on a guide rail of the hoist crane, reduce a period of construction after each carrier moves segments simultaneously with lifting segments, and disperse weight.

Addition, the present invention enables to provide the precast coping lifting system which installs work vehicles on the guide rail of the hoist crane and then instantly performs operation without installing a separate supporting post after listing segments.

### Types for Execution of the Invention

Hereinafter, an explanation of the precast coping lifting system according to the present invention will be given with reference to the attached drawings.

A detailed explanation on the known functions and configurations related to this invention will be avoided for the brevity of the description. And, the terms as will be mentioned below are used by the functions defined in this invention, which is of course varied in accordance with the intension or rules of a user or operator. Therefore, the definition of the terms should be based upon the contents of the description of the invention.

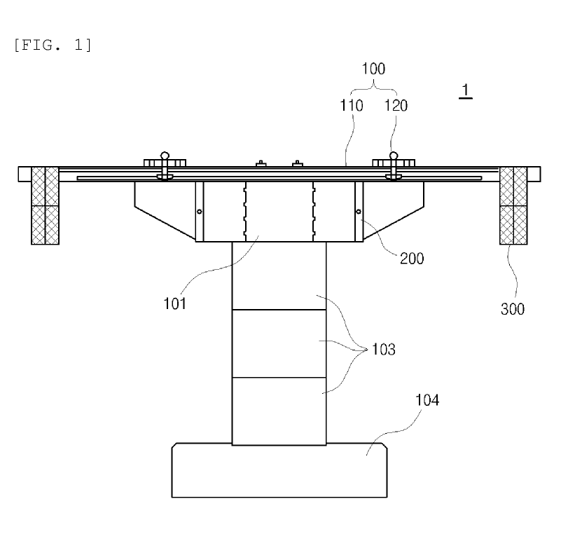

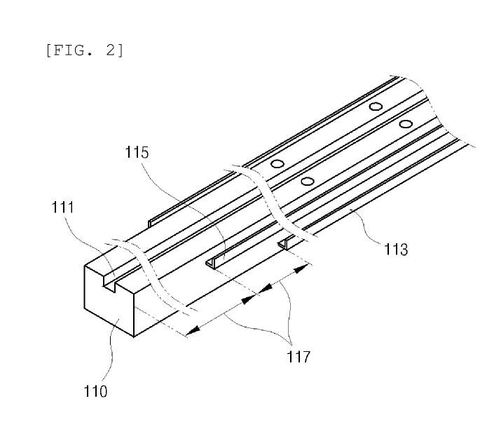

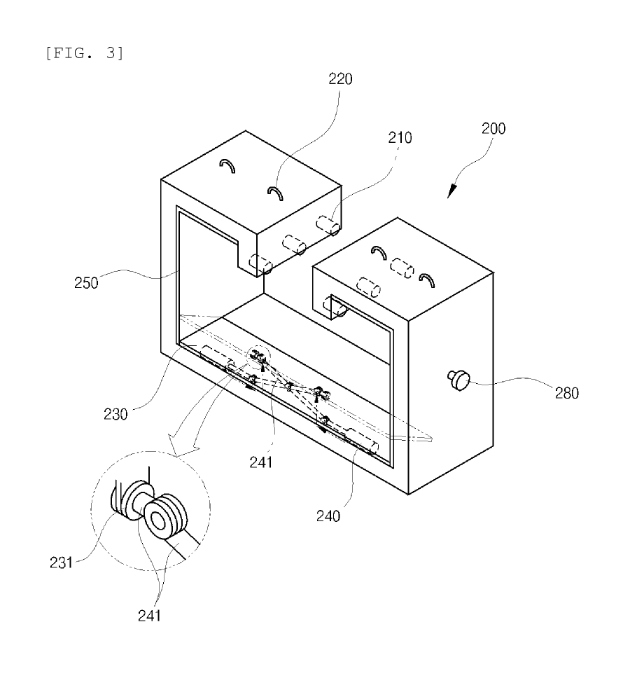

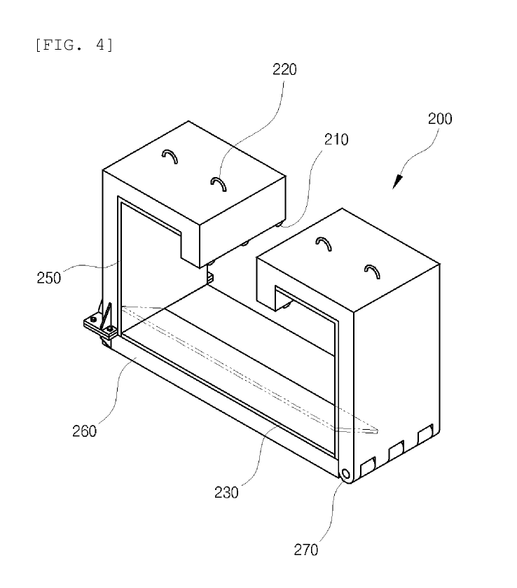

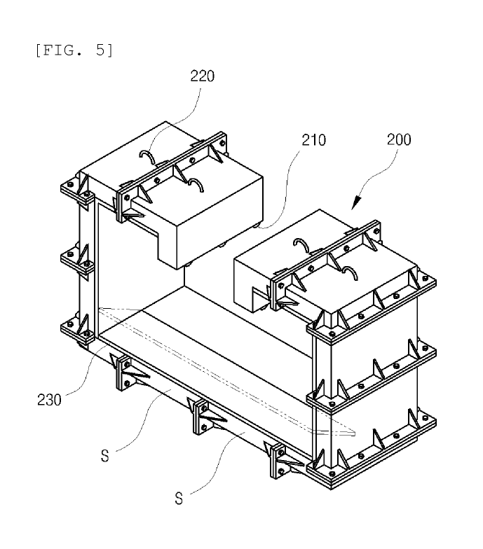

FIG. 1 is a side view representing the precast coping lifting system of the present invention; FIG. 2 is a side view representing the constitution of the horizontal support of the precast coping lifting system of the present invention; FIG. 3 is a perspective drawing representing the constitution of the clamp of the precast coping lifting system of the present invention; FIG. 4 is a perspective drawing representing the constitution of the clamp of the precast coping lifting system of other embodiments of the present invention; and FIG. 5 is a perspective drawing representing the constitution of the clamp of the precast coping lifting system of another embodiments of the present invention.

Referring to FIGS. 1 to 5, the precast coping lifting system (1) of the present invention consists of a hoist crane (100), a clamp (200), and work vehicles (300).

First, the hoist crane (100) is commonly equipped with a horizontal support (110) and a carrier (120) and includes the horizontal support (110) on the top of the main segment (101) and a pair of carriers (120) on the horizontal support (110).

Here, the horizontal support (110) may perform tension due to work vehicles placed on both ends of the precast coping which is combined to the main segment (101) and the subsegment (102), and it is desirable to have a length in which the clamp (200) may be connected to work vehicles each other.

Further, the horizontal support (110) includes a first guide rail (111) for moving the carrier (120) in longitudinal direction; a second guide rail (113) for being protruded in “L” shape to move the clamp (200) in both sides; and a third guide rail (115) for being protruded in “L” shape to move the work vehicles (300) while keeping a distance from the second guide rail (113). At this point, the second guide rail (113) and the third guide rail (115) form opening (117) in both ends so that the clamp (200) and the work vehicles (300) are lifted and combined by the carrier (120).

Furthermore, the horizontal support (110) is connected and fixed to the body segment (103) by using the steel bar (106) after installing the main segment (101) on the upper side of the body segment (103) under condition that the bridge base (104), the body segment (103) and the main segment (101) are tensioned by the longitudinal tendons (105), and is combined to the steel bar (106) on the upper side of the main segment (101). At this point, an anchor plate (107) and a sheath pier (108) are previously installed to the body segment (103) and the main segment (101) to combine the steel bar (106), respectively, and grouting materials are filled and integrated within the sheath pier (108) while combining the anchor plate (107) by using taps (not illustrated) formed in the steel bar.

Also, the clamp (200) is moved by the carrier (120) of the hoist crane (100) while being installed on the second guide rail (113) formed in the horizontal support (110) of the hoist crane (100), and fixes the subsegment (102) to the horizontal support (110).

Here, the clamp (200), made of metal, forms “ [symbol] ”-shaped sides to connect to the second guide rail (113) with having the subsegment (102), includes a plurality of wheels (210) on the bottom of both ends inside the top, and includes a connection ring (220) outside the upper side.

Also, it is desirable that the clamp (200) comprises an inclined support panel (230) for having a hinge spot (231) in the bottom inside for corresponding to a low inclined side of the subsegment (102); and ascending and descending means (240) for sticking the inclined support panel (230) to the low inclined side of the subsegment (102) with combining the hinge spot (231) and the axis (241) of the inclined support panel (230). At this point, it is desirable that hydraulic cylinder is applied to the ascending and descending means (240) and “X”-shaped roads are ascended and descended while being horizontally installed so that the ascending and descending means (240) is placed in a narrow space. In addition, an inclined side (not illustrated) may be built around one side of the clamp (200), helping the subsegment stored, and a roller (not illustrated) may be built to both sides inside.

Meanwhile, the clamp (200) further includes a rubber shock absorber (250) to protect damage of the subsegment (102) inside.

Further, when the clamp (200) is identically formed like FIG. 3 as illustrated in FIG. 4, the clamp (200) separates and combines one side and the bottom each other so that the clamp (200) and the subsegment (102) can be easily combined and dismantled, and the separated part (260) may be gathered by the hinge (270).

Furthermore, when the clamp (200) is identically formed like FIG. 3 as illustrated in FIG. 5, the up-and-down sides and both sides of the clamp (200) are separated by a segment unit (S) and combined each other so that the length of the clamp (200) may be changed in accordance with the size of the subsegment (102).

Furthermore, it is desirable that the clamp (200) protrudes and forms a fixed projection (280) to fix the clamp adjacent to both sides, or the clamp in opposite sides each other by using combination means (281) such as wires, chains, ropes.

Moreover, work vehicles (300), common work vehicles, are placed on the third guide rail (115) formed in the horizontal support (110) of the hoist crane (100), and are moved along the third guide rail (115) of the horizontal support (110) with self power. At this point, it is desirable that the work vehicles (300) have available spaces for storing the subsegment (102) and the clamp (200) inside the work vehicles (300) in order to install work space of workers and hydraulic apparatus.

Hereinafter, the process for operating the precast coping lifting system of the present invention is specifically explained by referring to attached drawings as below.

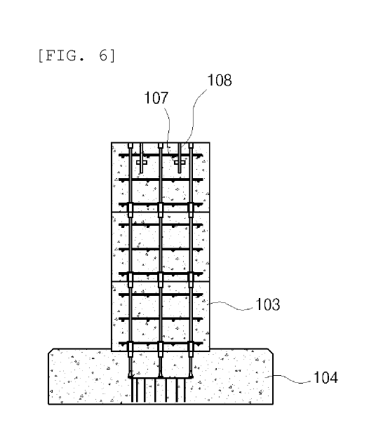

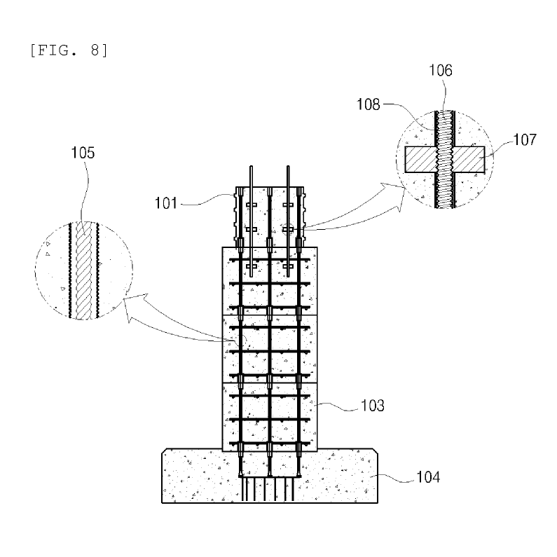

FIGS. 6 to 15 are explanation drawings for explaining the construction process using the precast coping lifting system of the present invention.

First, as illustrated in FIG. 6, after constructing the bridge base (104) on the surface, the pre-made bridge segment (103) is piled up on the upper side of the bridge base (104) to the designed height in a sequence. At this point, the anchor plate (107) and the sheath pier (108) are previously installed in the top of the body segment (103) to combine the steel bar (106).

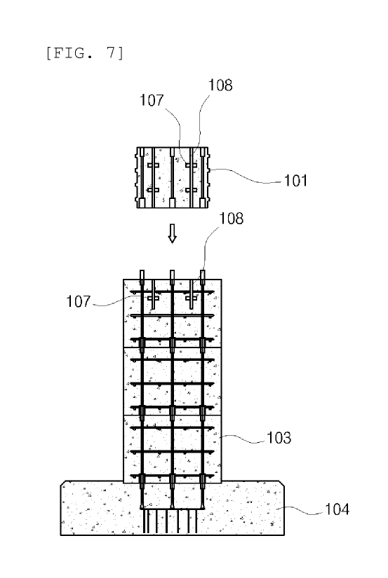

In this condition, as illustrated in FIG. 7, the pre-made main segment (101) is lifted and stacked on the upper side of the body segment (103) by lifting devices such as crane. At this point, it is desirable that the anchor plate (107) and the sheath pier (108) are previously installed to the main segment (101) to combine the steel bar (106), respectively, and the bottom of the main segment (101) is match-cast manufactured with the upper side of the body segment (103).

Next, the steel bar (106) is inserted into the body segment (103) and the main segment (101) and combined to the anchor plate (107), and the longitudinal tendons (105) are fixed after inserting and tensioning the longitudinal tendons (105) into the main segment (101), the body segment (103) and the bridge base (104) and introducing longitudinal tendon force.

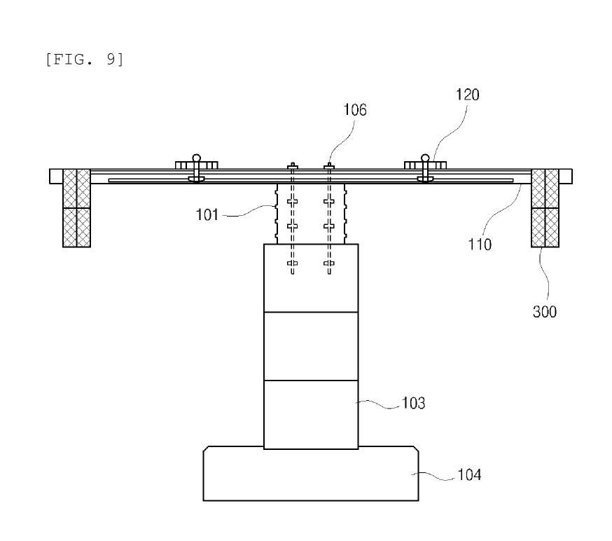

When the main segment (101) is completed to be fixed, as illustrated in FIG. 9, the horizontal support (110) is positioned on the upper side of the main segment (101) by using lifting devices such as crane and then, the horizontal support (110) is combined and fixed to the protruded steel bar (120) in the main segment (101). Next, when the steel bar (106) is completed to be fixed, the carrier (120) of the hoist crane (100) is lifted by lifting device and then, the carrier (120) is placed to the corresponding position.

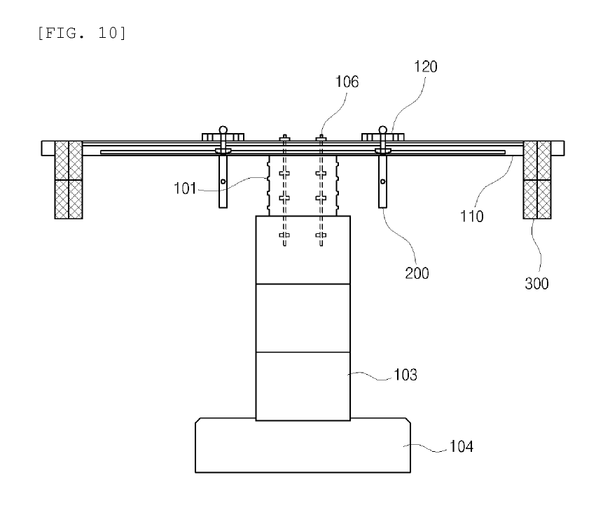

Then, when the hoist crane (100) is completed to be installed, as illustrated in FIG. 10, the cramp (200) and the work vehicles (300) are lifted through the carrier (120) of the hoist crane (100) and then, the cramp (200) and the work vehicles are placed to the second guide rail (113) and the third guide rail (115) which are formed on the horizontal support (110), respectively.

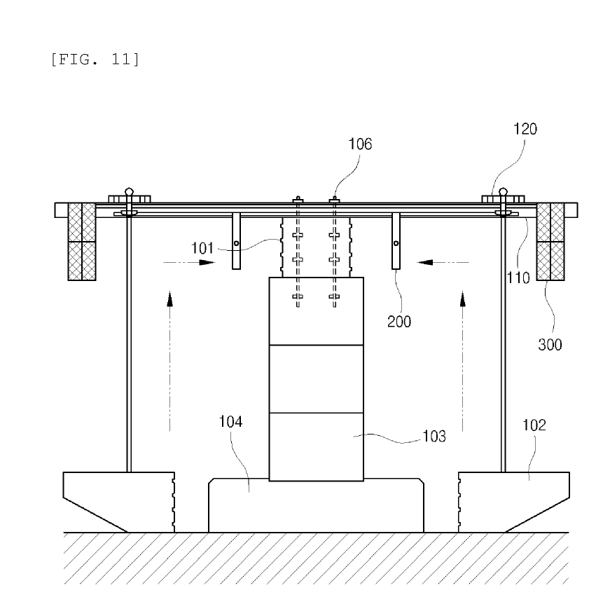

Next, as illustrated in FIG. 11, the subsegments (102) are joined to both sides of the main segment (101) by displaying the subsegments to each clamp (200) in both sides of the main segment (101) simultaneously with lifting a pair of subsegments (102) by using the carrier (120) of the hoist crane (100). At this point, the subsegments (102) should be kept horizontal by operating the slant support panel (230) of the clamp (200) and the ascending and descending means (240) and fixing the low inclined side of the subsegment (102). Also, it is desirable to cover epoxy of the subsegment (102) over the both sides of the main segment (101). Further, it is desirable that the main segment (101) and the subsegment (102) is match-cast manufactured.

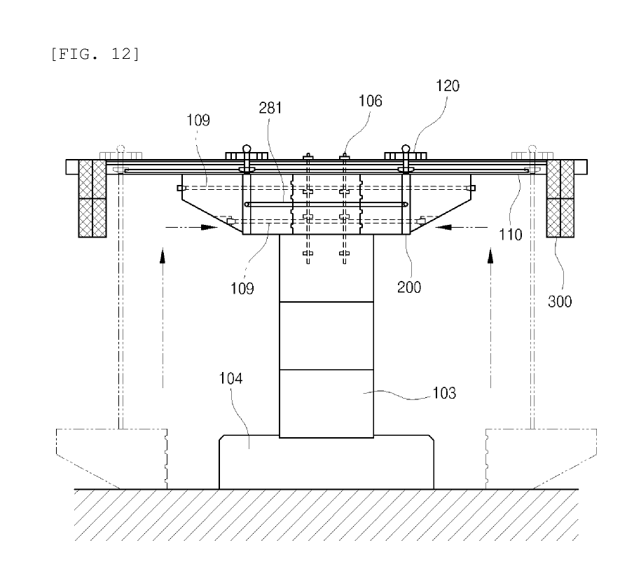

When the subsegment (102) is completed to be connected, as illustrated in FIG. 12, the work vehicles (300) are placed to both sides of the subsegment (102), and transverse tendons (109) are penetrated into the main segment (101) and the subsegment (102). Then, the transverse tendons (109) are fixed after tensioning the transverse tendons (109) and introducing the transverse tendon force.

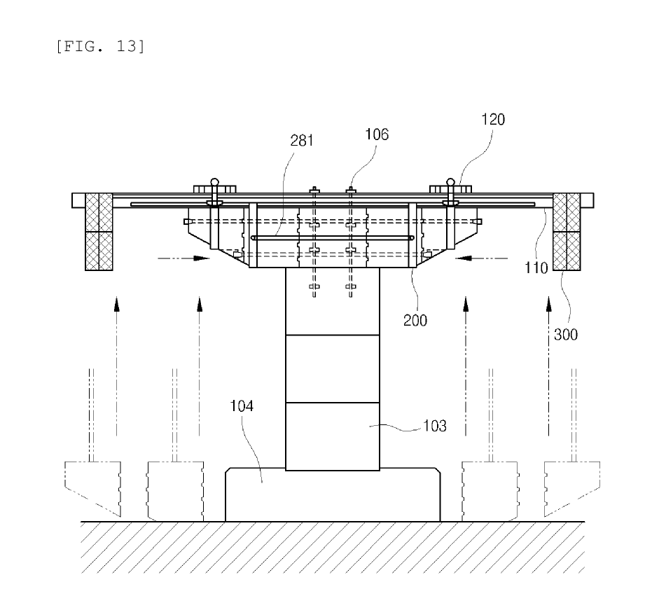

Meanwhile, in case that a separate subsegment is further installed close to the subsegment (102), as illustrated in FIG. 13, the additional clamp (200) is displayed to the second guide rail (113) in the horizontal support (110) by using the carrier (120) of the hoist crane (100) and the additional clamp (200) is moved to the side of the subsegment (102).

In this condition, the segment added by the above method is installed to the side of the pre-installed subsegment (102). At this point, it may be fixed each other by using adjacent clamp or clamps in other side and combination means (281) such as wires, chains or ropes by using the fixed projection (280) of the clamp (200).

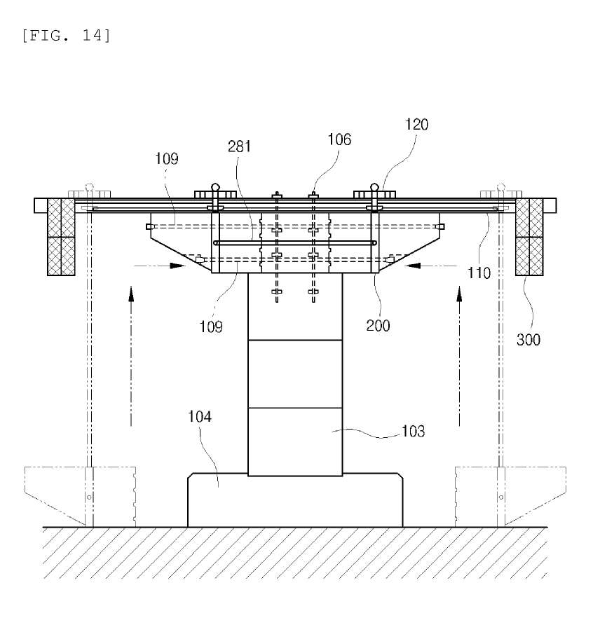

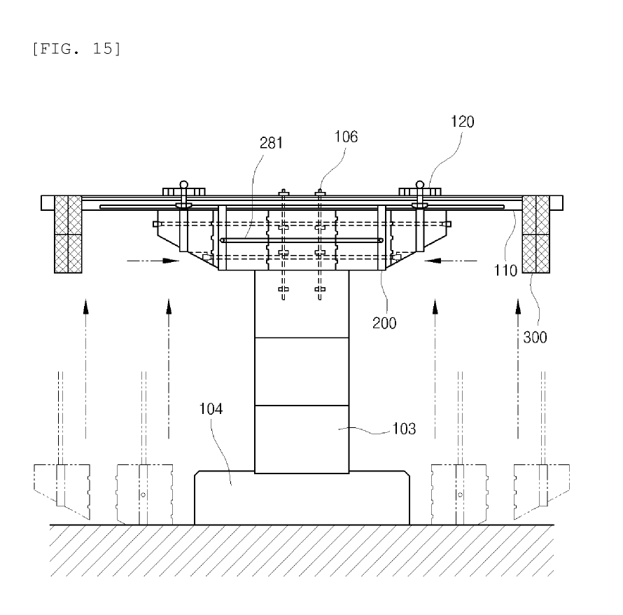

Moreover, even though the process for lifting and installing each of the clamp (200) and the subsegment (102) is explained from the above, as illustrated in FIGS. 14 and 15, after combining the subsegment (102) and the clamp (200) on the ground, the clamp (200) and the subsegment (102) is displayed to the second guide rail (113) in the horizontal support (110) respectively simultaneously with lifting the clamp (200) and the subsegment (102) and then, the clamp (200) and the subsegment (102) may be moved to each installation position.

When the subsegment (102) is completed to be installed, the carrier (120) is combined to the clamp (200); the clamp (200) and the subsegment (102) are separated by moving the carrier (120); and the carrier (120) is descended to the ground in accordance with the opposite method compared to the above. By using the above method, the work vehicle (300) is descended; the carrier (120) is descended to the ground with lifting devices such as crane; and the horizontal support (110) is descended with lifting devices such as crane after separate the fixed horizontal support (110) and the main segment (101). Then, separation process is completed.

Meanwhile, as illustrated in FIG. 5, in case that the clamp (200) is formed to be separated, a worker moves the clamp (200) with using the work vehicle (300) and the bottom of the clamp (200) is separated from the subsegment (102). Also, when the clamp (200) and the subsegment (102) are descended to the ground after separating the clamp (200) and the subsegment (102) by combining the carrier (120) to the clamp (200) and moving the carrier, the clamp (200) may be easily separated from the carrier (120). On the contrary, when the clamp (200) is also combined to the subsegment (102) on the ground, it may be easily combined each other.

The present invention can be variously modified and embodied by several types of forms, and particular illustrative embodiments are merely described in the detailed description of the invention. However, it should be appreciated in such a manner that the present invention is not limited as a particular type, mentioned in the detailed description, but rather it comprises all modified materials, equal materials, and substitutes within the spirit and the range of the present invention, defined by the enclosed claims herewith.

What is claimed is:

1. A precast coping lifting system having a main segment and a subsegment, characterized in comprising:
a hoist crane for installing a horizontal support on the upper side of the main segment and having a pair of carriers on the horizontal support;
a plurality of clamps for being installed on the horizontal support of the hoist crane, being moved by the carrier of the hoist crane, and fixing the subsegment to the horizontal support; and
work vehicles for being installed on the horizontal support of the hoist crane and being moved along the horizontal support by self power.

2. The precast coping lifting system according to claim 1, wherein the horizontal support includes
a first guide rail for moving the carrier in longitudinal direction of the horizontal support;
a second guide rail for being protruded in “L” shape to move the clamp in both sides of the horizontal support; and
a third guide rail for being protruded in “L” shape to move the work vehicles while keeping a distance from the second guide rail.

3. The precast coping lifting system according to claim 2, wherein the second guide rail and the third guide rail form opening in both ends so that the clamp and the work vehicles are lifted and combined by the carrier.

4. The precast coping lifting system according to claim 1, wherein the clamp, made of metal, forms “ [symbol] ”-shaped sides to connect to the second guide rail with having the subsegment, includes a plurality of wheels on the bottom of both ends inside the top, and includes a connection ring outside the upper side.

5. The precast coping lifting system according to claim 4, wherein the clamp further comprises
an inclined support panel for having a hinge spot in the bottom inside for corresponding to a low inclined side of the subsegment; and
ascending and descending means for sticking the inclined support panel to the low inclined side of the subsegment with combining the hinge spot and the axis of the inclined support panel.

6. The precast coping lifting system according to claim 4, wherein the clamp further comprises a shock absorber to protect damage of the subsegment inside.

7. The precast coping lifting system according to claim 4, wherein the clamp separates one side and the bottom each other so that the clamp and the subsegment can be easily combined and dismantled, and the separated part is gathered by a hinge.

8. The precast coping lifting system according to claim 4, wherein the up-and-down sides and both sides of the clamp are separated by a segment unit and combined each other so that the length of the clamp may be changed in accordance with the size of the subsegment.

9. The precast coping lifting system according to claim 4, wherein the clamp protrudes and forms a fixed projection to fix the clamp adjacent to both sides, or the clamp in opposite sides each other by using combination means such as wires, chains, ropes.

10. The precast coping lifting system according to claim 1, wherein the horizontal support is combined and fixed to the body segment by using a steel bar after installing the main segment on the upper side of the body segment, and is combined to the steel bar on the upper side of the main segment under the condition that a pier bridge, the body segment and the main segment are longitudinally tensioned.
